(19) United States
(12) Patent Application Publication
(10) Pub. No.: US 2008/0008842 A1
(43) Pub. Date: Jan. 10, 2008

(54) Method for plasma processing

(75) Inventors: Jyr Hong Soo, Santa Clara, CA (US); Matthew Spuller, Palo Alto, CA (US); Michael S. Cox, Davenport, CA (US); Martin Jay Seamons, San Jose, CA (US); Amir Al-Bayati, San Jose, CA (US); Bok Hoen Kim, San Jose, CA (US); Hichem M'Saad, Santa Clara, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/483,951

(22) Filed: Jul. 7, 2006

(51) Int. Cl. H05H 1/24

(52) U.S. Cl. 427/569; 427/576

(57) ABSTRACT

Methods for reducing plasma instability for plasma depositing a dielectric layer are provided. In one embodiment, the method includes providing a substrate in a plasma processing chamber, flowing a gas mixture into the chamber, applying an RF power to an electrode to form a plasma in the chamber, and collecting DC bias information. In another embodiment, the method for plasma processing includes obtaining of DC bias information over a plurality of plasma generation events, and determining an RF power application parameter from the DC bias information.

### BACKGROUND OF THE INVENTION

1. Field of the Invention

The present invention generally relates to semiconductor processing technologies and, more specifically, to a method for plasma processing suitable for plasma enhanced chemical vapor deposition (PECVD) processes, among other plasma processes.

2. Description of the Related Art

In the manufacture of integrated circuits, plasma processes are often used for deposition or etching of various material layers. Plasma processing offers many advantages over thermal processing. For example, plasma enhanced chemical vapor deposition (PECVD) allows deposition processes to be performed at lower temperatures and at higher deposition rates than achievable in analogous thermal processes. Thus, PECVD is advantageous for integrated circuit fabrication with stringent thermal budgets, such as for very large scale or ultra-large scale integrated circuit (VLSI or ULSI) device fabrication.

One problem that has been encountered with plasma processing in integrated circuit fabrication is that devices may become damaged as a result of exposure to non-uniform plasma conditions, such as electric field gradients. For example, RF power in-rush occurring during plasma ignition may result in non-uniform plasma generation and distribution in the process region. The susceptibility or degree of device damage depends on the stage of device fabrication and the specific device design. For example, a substrate having a relatively large antenna ratio (e.g., area of metal interconnect to gate area) is more susceptible to arcing during plasma ignition than a substrate having a smaller antenna ratio. The substrate having a relatively large antenna ratio also tends to collect charges and amplify the charging effect, thereby increasing the susceptibility to plasma damage, such as arcing to the device being formed on the substrate. Devices containing an insulating or dielectric layer deposited on a substrate are susceptible to damage due to charges and/or potential gradients accumulating on the surface of the dielectric layer.

Additionally, the accumulation of charges or buildup of electrical gradients on the substrate may cause destructive currents to be induced in portions of the metallized material. The induced current often results in arcing between dielectric layers and/or to the processing environment (e.g., system component). Arcing may not only lead to device failure and low product yield, but may also damage components of the processing system, thereby shortening the useful life of system components. The damaged system components may cause process variation or contribute to particle generation, both of which may further reduce product yield. As the feature size of devices becomes smaller and dielectric layers become thinner, prevention of unstable and/or non-uniform plasma distribution becomes increasingly critical not only for ensuring attainment device electrical performance and product yield, but also for extending the service life of system components and managing system operating costs.

Therefore, there is a need for an improved method for plasma processing.

### SUMMARY OF THE INVENTION

Methods for plasma processing are provided in the present invention. In one embodiment, the method for plasma processing includes providing a substrate in a plasma processing chamber, flowing a gas mixture into the chamber, applying an RF power to an electrode to form a plasma in the chamber, and collecting DC bias of the electrode.

In another embodiment, the method for plasma processing includes obtaining of DC bias information over a plurality of plasma generation events, and determining an RF power application rate from the DC bias information.

In yet another embodiment, the method for plasma processing includes plasma processing a plurality of substrates using different RF power application rates, obtaining a metric indicative of processing associated with each power application rate, determining a power application criteria from the metric that promotes processing, and plasma processing a substrate at a power application parameter defined by the power application criteria.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

FIG. 1 is a cross sectional view of one embodiment of an exemplary plasma processing chamber having a data acquisition system in which at least one embodiment of a method for plasma processing may be practiced;

FIG. 2 is a process flow diagram illustrating one embodiment of a method for plasma processing; and

FIG. 3 is a DC bias trace obtained from a data acquisition system according to one embodiment of the present invention.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

Embodiments of the present invention include methods for plasma processing. The method may be employed to reduce plasma instability and/or improve substrate processing. The plasma process may be part of a deposition process, etch process, annealing process, surface treatment process or other suitable plasma process. In one embodiment, the method provided herein advantageously improves plasma stability in a plasma processing chamber by optimizing the ramp-up rate of RF power applied during processing. Substrates having a patterned structure with an antenna ratio over 50,000 may be used for amplifying and/or enhancing a discharge effect which may occur during the plasma process. A data acquisition system is used to collect DC bias information during processing, which is utilized to optimize the RF power ramp-up rate. The RF power ramp-up rate is optimized to obtain a DC bias variation during ramp-up that is less than a determined value. The optimizing RF power ramp-up rate allows the plasma generated in the processing chamber to be distributed uniformly across the substrate in the chamber, substantially eliminating the discharge effect and arcing damage, and thus providing a robust product yield while extending the life of chamber components.

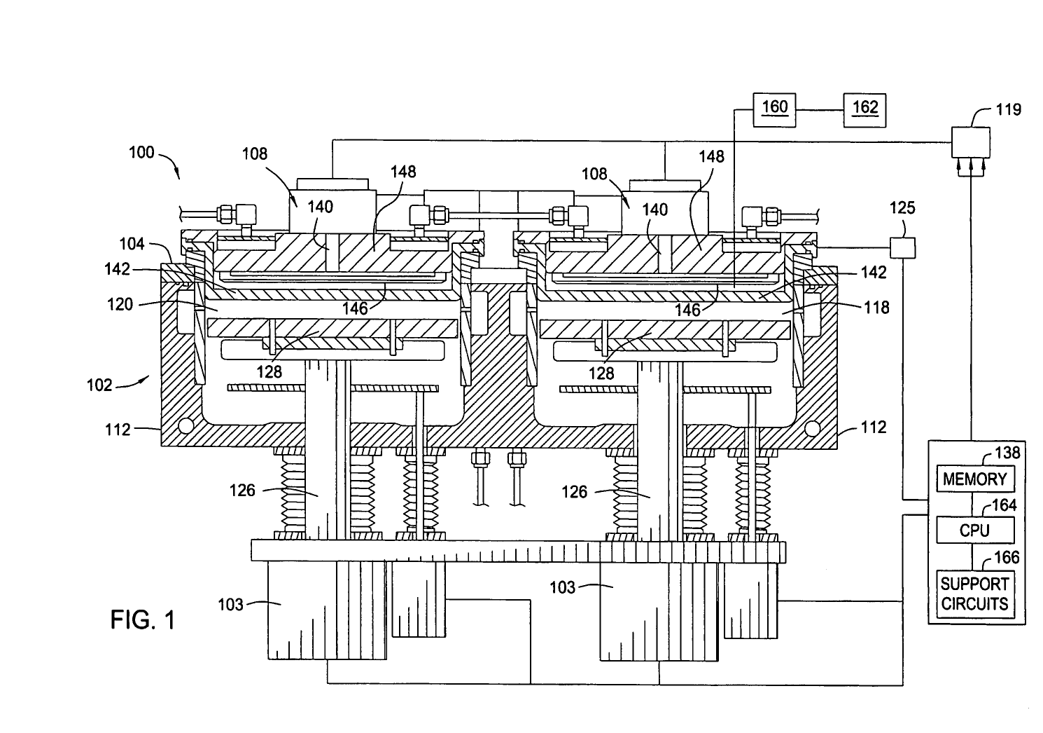

FIG. 1 presents a cross-sectional, schematic diagram of a plasma enhanced chemical vapor deposition (PECVD) chamber 100 having a data acquisition system 162 for collecting bias voltage information. One PECVD chamber that may be adapted to benefit from the invention is a Producer® CVD chamber, available from Applied Materials, Inc., Santa Clara, Calif. Another chamber having two isolated processing regions that may be adapted to benefit from the invention is described in U.S. Pat. No. 5,855,681, which is incorporated by reference herein. It is contemplated that other plasma processing chambers, including those available from other manufacturers, may be adapted to practice the invention.

The chamber 100 has a body 102 that defines separate processing regions 118, 120. Each processing region 118, 120 has a pedestal 128 adapted to support a substrate (not shown) within the chamber 100. The pedestal 128 may include a heating element (not shown). The pedestal 128 is coupled by a stem 126 to a drive system 103 that controls the elevation of the pedestal 128 in each processing region 118, 120. Internal movable lift pins (not shown) may be provided in the pedestal 128 to facilitate the movement of the substrate disposed on the pedestal 128. The lift pins are adapted to lower or to raise the substrate off the pedestal 128 as needed.

A lid 104 is coupled to the top portion of the chamber body 102. The lid 104 includes a gas distribution assembly 108 comprising a manifold 148, a blocker plate 146 and a showerhead 142. A gas inlet passage 140 is included in the gas distribution assembly 108 and is coupled to a gas panel 119 to facilitate the flow of process gases into processing regions 118, 120 through the showerhead 142. The showerhead 142 is located above the pedestal 128 and disperses a process gas mixture into the process regions 118, 120. The showerhead 142 may also comprise different zones, such that various gases may be released into the chamber 100 at various flow rates and/or at various volumetric distributions.

An RF (radio frequency) source 125 is used to provide a bias potential to the showerhead 142 to facilitate plasma generation between the showerhead 142 and the pedestal 128. The showerhead 142 and the pedestal 128 form a pair of spaced apart electrodes to facilitate plasma generation in the presence of process gas mixture in the processing regions 120, 118. The source 125 generally comprises an RF generator (not shown) and a matching network (not shown). The RF source 125 may provide a single or mixed-frequency RF signal frequency to the showerhead 142. In one embodiment, the source 125 generally is capable of producing up to 5000 W of continuous or pulsed power at an RF signal frequency ranging from about 50 kHz to 60 MHz. Alternatively, the RF source 125 may be coupled to the pedestal 128 or to both the showerhead 142 and pedestal 128.

In one embodiment, the pedestal 128 may serve as a cathode for generating RF bias within the chamber body 102 in a plasma-enhanced chemical vapor deposition process. The cathode is electrically coupled to an electrode power supply (not shown) to generate a capacitive electric field in the deposition chamber 100. Power applied to the pedestal 128 creates a substrate bias in the form of a negative voltage on the upper surface of the substrate. This negative voltage is used to attract ions from the plasma formed in the chamber 100 to the upper surface of the substrate. The capacitive electric field forms a bias which accelerates inductively formed plasma species toward the substrate to provide a more vertically oriented anisotropic filming of the substrate during deposition and etching of the substrate during cleaning.

The data acquisition system 162 is coupled to at least one of the showerhead 142 or pedestal 128 and is utilized to collect the bias voltage of at least one of the electrodes generating the plasma within the chamber 100. The data acquisition system 162 may be configured to collect data samples over a predetermined time period. In one embodiment, the data acquisition system 162 may collect up to 10 million data samples per second from a voltage probe 160 coupled to the showerhead 142.

During processing, process gases are distributed radially across the substrate surface. The plasma is formed from one or more process gases by applying RF energy from the RF power supply 125 to the showerhead 142. As the RF power is applied to the showerhead 142, the data acquisition system 162 is operated to collect the bias generated in the showerhead 142.

A system controller 134 comprises a central processing unit (CPU) 164, a memory 138, and a support circuit 166 coupled to the chamber 100 utilized to control process sequence and regulate the gas flows from the gas panel 119. The CPU 164 may be of any form of a general purpose computer processor that can be used in an industrial setting. The software routines can be stored in the memory 138, such as random access memory, read only memory, floppy or hard disk drive, or other form of digital storage. The support circuit 166 is conventionally coupled to the CPU 164 and may comprise cache, clock circuits, input/output subsystems, power supplies, and the like. The software routines, when executed by the CPU 164, transform the CPU into a specific purpose computer (controller) 134 that controls the process chamber 100 such that the processes are performed in accordance with the present invention. The software routines may also be stored and/or executed by a second controller (not shown) that is located remotely from the chamber 100.

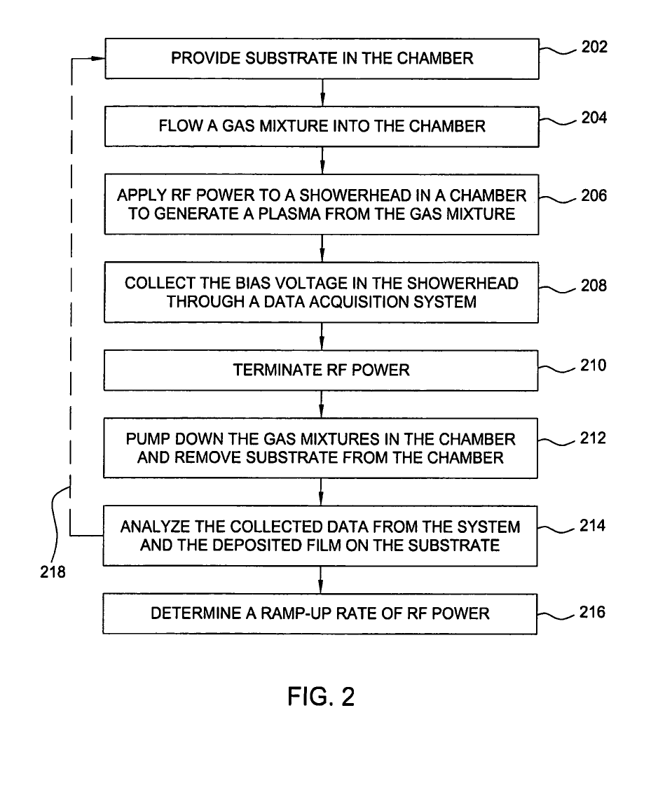

FIG. 2 depicts a process flow diagram of one embodiment of a method 200 for plasma processing that may be performed in the chamber 100, or other suitable plasma processing chamber. In one embodiment, the method 200 may be performed to optimize an application parameter of an RF power applied to ignite the plasma by using the data acquisition system 162 to track the DC bias of the showerhead 142 or other electrode capable of providing a metric indicative of the bias voltage. The RF power application parameters may include ramp-up rate, ramp-up period, RF signal physical attributes during the ramp-up period (such as frequency, frequency mix, change in frequencies, amplitude, change in amplitudes, shape of a power application curve, among others) and the like.

The method 200 begins at step 202 by providing a substrate in the chamber 100. The substrate may have patterned structures with a relatively large antenna ratio disposed thereon to amplify the potential arcing, or discharge non-uniformity across the substrate when exposed to plasma. In one embodiment, the substrate may have patterned structures having an antenna ratio larger than about 50,000 disposed thereon. In another embodiment, the substrate may have patterned structures having an antenna ratio larger than about 700,000. In yet another embodiment, the substrate may have patterned structures similar as the structures disposed on a production wafer. In still another embodiment, the substrate may be a production wafer or other workpiece.

At step 204, one or more gases are flowed into the chamber. The gas or gas mixture supplied to the chamber may be utilized to perform or simulate one or more of the processes performed in the chamber. For example, the gases may be thermally decomposed to deposit a dielectric layer, such as an amorphous carbon film, on the substrate. It is contemplated that other plasma processes may be performed, including deposition, etching, annealing or thermal treatment, or an etching process. In one embodiment, the gas mixture contains a hydrocarbon compound and an inert gas, such as argon (Ar) and/or helium (He). The hydrocarbon compound has a general formula CₓH_{y}, where x has a range between 1 and 6 and y has a range between 2 and 14. For example, propylene (C₃H₆), propyne (C₃H₄), propane (C₃H₈), butane (C₄H₁₀), butylenes (C₄H₈), butadience (C₄H₆), or acetelyne (C₂H₂) as well as combinations thereof, may be used as the hydrocarbon compound. Similarly, a variety of gases, such as hydrogen (H₂), nitrogen (N₂), ammonia (NH₃), or combination thereof, may be added to the gas mixture. As the exemplary embodiment, the gas mixture includes C₃H₆, He and Ar.

Process parameters are regulated at step 204 while the gas mixture is supplied into the chamber 100. In one embodiment, a pressure of the gas mixture disposed in the chamber is regulated between about 1 Torr and about 30 Torr, for example, between about 4 Torr and about 10 Torr. The substrate temperature is maintained between about 75 degrees Celsius and about 600 degrees Celsius, for example, about 200 degrees Celsius and about 550 degrees Celsius. The spacing between the showerhead 142 and the substrate pedestal 128 is set to between about 50 mils and about 2000 mils, for example, about 200 mils and about 400 mils. The gas flow of hydrocarbon compound, such as C₃H₆, is provided to the chamber at a flow rate between about 200 sccm to about 4000 sccm, for example, about 600 sccm to about 1800 sccm. The gas flow of inert gas, such as Ar, is flowed into the chamber at a rate between about 0 sccm to about 10000 sccm, for example, about 0 sccm to about 4000 sccm. In an embodiment where the inert gas is He, the gas flow of He is provided to the chamber at a flow rate between about 0 sccm to about 2000 sccm, for example, about 200 sccm to about 1000 sccm.

At step 206, an RF power is applied to the showerhead 142 of the chamber 100 to generate a plasma from the gas mixture within the chamber 100. Variations in the DC bias of the showerhead 142 are monitored during the RF power application. To obtain an optimized parameter for RF power application, the plasma process is performed using different RF power application parameters so that multiple DC bias data sets may be collected. The application parameters may have different power application rates, different time periods over which the power is ramped-up and/or other parameter change which may be analyzed to determine an optimal operation set-point. For example, the RF ramp-up may be sampled over rates having power applications of between about 20 Watt/seconds and 5000 Watts/seconds, for example, between about 50 Watt/seconds and 1000 Watts/seconds to generate a data set suitable for optimizing the RF power application. The period of the ramp-up time for the RF power into the predetermined range is set between 0.1 seconds to 100 seconds.

The RF power applied at step 206 may ramp-up the RF power to a final set-point value suitable for depositing an amorphous carbon or other film. In one embodiment, the final set-point value for an amorphous carbon deposition process may be set at between about 500 Watts and about 2000 Watts, while ramping up the RF power density at a rate between about 0.15 W/cm₂/sec and about 0.75 W/cm₂/sec in a 300 mm substrate processing chamber. In another embodiment, the final set-point value may be at a range between about 50 Watts and about 500 Watts, while ramping up the RF power density at a rate between about 0.01 W/cm₂/sec and about 0.75 W/cm₂/sec in a 300 mm substrate processing chamber.

At step 208, the data acquisition system 162 coupled to the showerhead 142 is operated to collect DC bias information obtained during the RF ramp-up. The data acquisition system 162 collects and receives the value of DC bias of the showerhead 142 from the voltage probe 160 over a predetermined time interval. In one embodiment, the data acquisition system 162 samples a metric of DC bias about every 0.1 milliseconds (ms) to about every 500 milliseconds (ms) until the RF power is stabilized or terminated. In another embodiment, the data acquisition system 162 samples a metric of DC bias about every 80 ms to about every 250 ms, such as 200 ms.

At step 210, the RF power is terminated after depositing the amorphous carbon or other film. At step 212, the gas mixture flow into the chamber is stopped and the chamber throttle valve is opened to allow the process gas mixture to be pumped out of the chamber after RF power termination. The substrate is subsequently removed from the process chamber.

Step 202 to step 212 may be performed repeatedly to obtain a plurality of DC bias data sets from substrates processed using different RF power application parameters, ramp-up rate settings and/or different power application periods, as indicated by the loop 218 depicted in FIG. 2, so as to facilitate analyzing the process by comparing the different inspection results. The data sets provide information regarding the relationship between the film properties (and/or device performance) and the variations of DC bias of showerhead over different process conditions.

At step 214, the DC bias data set is analyzed by one of the data acquisition system 162, controller 134 or other processor. The processed substrates may also be inspected and evaluated by an inspection tool, such as Scanning Electron Microscopy (SEM), thickness measuring tool, optical measuring tool, conductance measuring tool or other tool suitable for evaluating substrate and/or device processing, performance and/or physical characteristic.

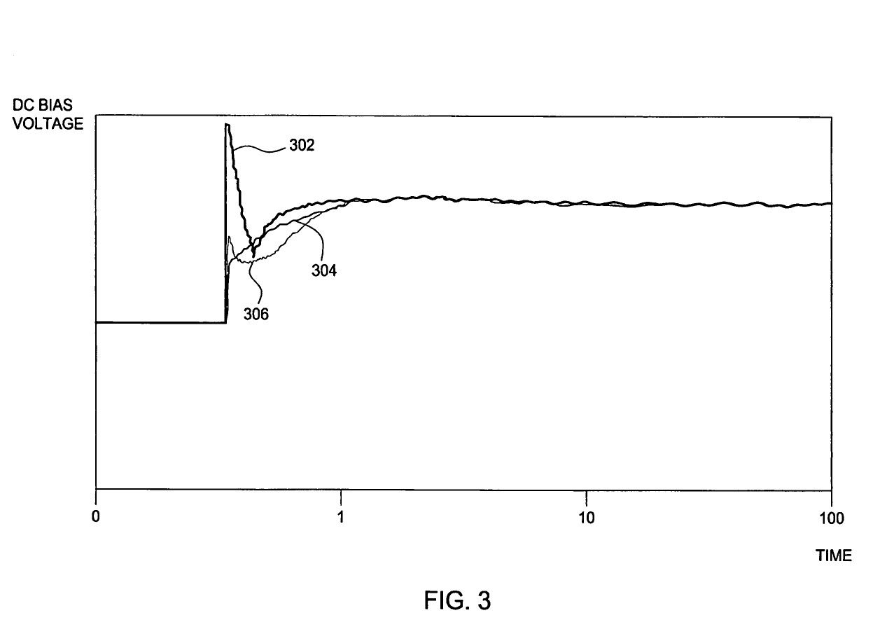

FIG. 3 shows several DC bias traces 304, 306 for the processes performed using different RF power ramp-up rates compared with a DC bias trace 302 for substrates having the same antenna ratio processed with a step application of RF power. The substrate, when subjected to a step application of RF power 302 (e.g., 9999 Watts/s), exhibited arcing in the process chamber and had particle contamination on the substrate surface. The step application of RF power applied to the showerhead 142 creates a large fluctuation of DC bias 302 of showerhead (over 10 Volts) which undesirably promotes plasma discharge at localized regions of the substrate. Substrates with large antenna ratios tend to amplify the discharging effect, and therefore, the substrate and/or the processing chamber exposed to this RF spike may become damaged.

The DC bias trace 306 illustrates a more stable process as compared to the step RF power application trace 302, but not as stable as the trace 304. The DC bias trace 304 has a smooth transition from power application to a steady state processing condition. The smooth transition of DC bias is indicative of processes having stable plasma generation and uniform plasma distribution within the process region, which minimize charge accumulation and arcing. Additionally, the substrates processed in this manner have higher product yields in comparison with the substrates processed with processes having large DC fluctuation bias. The elimination of the localized charge due to non-uniform plasma distribution advantageously minimizes arcing and defect generation on the substrate and system components, and thereby promoting higher product yield and longer service of the processing chamber components.

At step 216, an optimized ramp-up rate of the RF power is determined by analyzing the DC bias information. Inspection results may also be considered to determine which ramp-up rates exhibit less contamination and/or process damage. In one embodiment, measured variation in the DC bias during RF ramp-up of less than 3 volts, such as 1 volt, enables good processing results. In another embodiment, inspection of processed substrate indicates that a variation in DC bias of less than 5 volts provides a relatively higher product yield and acceptable particle counts. To achieve the variation in DC bias of less than 3 volts, such as 1 volt, the optimized ramp-up rate is selected at a range between about 100 Watts/sec and 500 Watts/sec for the amorphous carbon deposition process described above. The selected range of optimized RF ramp-up rate provides an arcing-free process condition, thereby efficiently providing a longer service of the process components and robust product yield. Of course, other processes will have different optimized rates.

Thus, the present application provides methods for reducing plasma instability in a plasma processing chamber. The methods advantageously promote stability and uniformity of the plasma by optimizing an RF power ramp rate. The optimized process minimizes potential plasma damage to the substrate and processing system and, thus, promotes robust product yields and long service life of system components.

While the foregoing is directed to embodiments of the present invention, other and further embodiments of the invention may be devised without departing from the basic scope thereof, and the scope thereof is determined by the claims that follow.

What is claimed is:

1. A method for plasma processing, comprising:
providing a substrate in a plasma processing chamber;
flowing a gas mixture into the chamber;
applying an RF power to an electrode to form a plasma in the chamber;
collecting a metric indicative of DC bias of the electrode; and
adjusting an application parameter of the RF power applied to the electrode in response to the collected metric.

2. The method of claim 1, wherein the substrate has a patterned structure with an antenna ratio larger than 50,000.

3. The method of claim 1, further comprising:
inspecting the substrate after processing to obtain data indicative of processing; and
correlating the obtained data and the collected metric to determine the adjustment for the application parameter.

4. The method of claim 1, wherein adjusting the application parameter further comprises:
adjusting an RF power ramp-up rate.

5. The method of claim 4, wherein the RF power ramp-up rate is between about 20 Watts/second and about 5000 Watts/second.

6. The method of claim 1, wherein adjusting the application parameter further comprises:
adjusting an RF power ramp-up period.

7. The method of claim 1, comprising:
depositing a dielectric film on the substrate.

8. The method of claim 7, wherein the dielectric film is an amorphous carbon film.

9. The method of claim 1, wherein the substrate has a patterned structure with an antenna ratio larger than 700,000.

10. The method of claim 1, wherein the step of flowing the gas mixture further comprises:
flowing the gas mixture containing a hydrocarbon compound and at least one inert gas into the chamber.

11. The method of claim 10, wherein the at least one inert gas is selected from a group consisting of Ar, He, H₂, N₂, and NH₃.

12. The method of claim 10, wherein the hydrocarbon compound is selected from a group consisting of C₃H₆, C₃H₄, C₃H₈, C₄H₁₀, C₄H₈, C₄H₆, and C₂H₂.

13. The method of claim 10, wherein the step of flowing the gas mixture further comprises:
flowing the hydrocarbon compound at a flow rate between about 200 sccm and about 4000 sccm; and
flowing the at least one inert gas at a flow rate between about 0 sccm and about 10000 sccm to deposit an amorphous carbon film.

14. The method of claim 10, wherein the substrate is a production wafer having patterned features disposed thereon.

15. The method of claim 1, wherein collecting the metric indicative of DC bias of the electrode further comprises:
sensing a DC bias of a showerhead disposed in the processing chamber.

16. A method for plasma processing, comprising:
obtaining DC bias information over a plurality of plasma generation events; and
determining an application parameter for RF power applied during plasma generation from the DC bias information.

17. The method of claim 16, wherein obtaining DC bias information further comprises:
exposing a substrate having an antenna ratio greater than about 50,000 to a plasma during at least one of the plasma generation events.

18. The method of claim 16, wherein obtaining DC bias information further comprises:
exposing a substrate having an antenna ratio greater than about 700,000 to a plasma during at least one of the plasma generation events.

19. The method of claim 16, further comprising:
inspecting at least one substrate exposed to a plasma during at least one of the plasma generation events to obtain data indicative of processing; and
correlating the obtained inspection data and the DC bias information to determine an optimized application parameter.

20. The method of claim 16, wherein determining the application parameter further comprises:
adjusting an RF power ramp-up period.

21. The method of claim 16, wherein determining the application parameter further comprises:
adjusting an RF power ramp-up rate.

22. The method of claim 16, further comprising:
depositing an amorphous carbon layer on the substrate.

23. A method for plasma processing, comprising:
plasma processing at least a first substrate using different RF power application rates;
obtaining a metric indicative of processing for each RF power application rate;
determining a power application criteria from the metric that promotes processing; and
plasma processing a second substrate at a power application rate defined by the power application criteria.

24. The method of claim 23, wherein the first substrate has an antenna ratio larger than about 50,000.

25. The method of claim 23, wherein the at least first substrate further comprises:
a plurality of non-production substrates, and wherein the second substrate is a production substrate.

26. The method of claim 23, wherein the determined the power application criteria is a ramp-up rate of RF power utilized to generate a plasma.
